(19) United States
(12) Patent Application Publication
(10) Pub. No.: US 2016/0255393 A1
(43) Pub. Date: Sep. 1, 2016

(54) BROWSER-BASED METHOD AND DEVICE FOR INDICATING MODE SWITCH

(71) Applicant: LEMOBILE INFORMATION TECHNOLOGY (BEIJING) CO., LTD., Beijing (CN)

(72) Inventors: Shaopeng YU, Beijing (CN); Fan LIANG, Beijing (CN)

(21) Appl. No.: 15/033,605

(22) PCT Filed: Oct. 22, 2014
(86) PCT No.: PCT/CN2014/089199

§ 371 Date: Apr. 29, 2016

(30) Foreign Application Priority Data
Oct. 30, 2013 (CN) 201310530874.3

(51) Int. Cl. H04N 21/422; H04N 21/4782

(52) U.S. Cl. CPC H04N 21/42222; H04N 21/4782; H04N 21/42216

(57) ABSTRACT

An embodiment of the present disclosure discloses a browser-based method and device for indicating mode switch. The browser-based method and device can be applied to a smart TV. With the method and device, an air mouse mode can be started when the smart TV enters into the browser, a mouse cursor is controlled to move on a browser page through the air mouse mode of a remote controller, and a user can browse a web flexibly; and when the smart TV exits a browser interface, a focus mode can be started, and focus control over a screen display interface of the smart TV can be achieved through the remote controller. The indication mode switching method and device are suitable for the operation habit of the user to a common TV program, and user experience is improved.

### CROSS-REFERENCE TO RELATED APPLICATIONS

The present disclosure is a national stage of International Application No. PCT/CN2014/089199, filed Oct. 22, 2014, which is based upon and claims priority to Chinese Patent Application No. 201310530874.3, filed on 30 Oct. 2013 and entitled “browser-based method and device for indicating mode switch”, the entire contents of all of which are incorporated herein by reference.

### FIELD OF TECHNOLOGY

The present disclosure belongs to the field of smart TV, and particularly to a browser-based method and device for indicating mode switch.

### BACKGROUND

The TV is the most common domestic appliance in modern society. With the development of technology and science, it has a full-open platform, and a smart TV with an operating system emerges at a historic moment. While watching common TV content on a smart TV, a user can install and uninstall various types of application software himself/herself, can continuously expand and upgrade the function of the smart TV and can bring rich personalized experience.

With further development of the smart TV, a remote controller dedicated to the smart TV also emerges at a historic moment. The smart TV can realize web browsing. When the user browses the web in a browser, the remote controller dedicated to the smart TV is used to control and operate the web. Since there is a large number of links on the web, the user needs to control a focus frame to move on the web through the remote controller when browsing the web content. Control information is generated by each control action of the user on the remote controller, and the smart TV controls the focus frame to move to an adjacent position according to the control information. When the user browses the web, he/she usually needs to operate the links in the web, and when the target link is far from the current link, the user needs to execute the same control action multiple times to click the unnecessary focus, causing a tedious target operation process and bad user experience.

### SUMMARY

One of the purposes of the present disclosure is to provide a browser-based method and device for indicating mode switch. An air mouse mode is started when the user enters into the browser. A mouse cursor is controlled to move on a browser page through the air mouse mode of the remote controller, so as to browse the web flexibly.

A browser-based method for indicating mode switch, the method being applied to a smart TV, characterized by including:
receiving and parsing control information sent by a remote controller of the smart TV; when the control information is request information for entering the browser, generating a switch-to-air mouse mode command; calling a remote controller mode switching port to send the switch-to-air mouse mode command to the remote controller, such that the remote controller enters into an air mouse mode, and displaying a mouse cursor on a browser interface, such that the remote controller controls the mouse cursor to move;
when the control information is exit information for exiting the browser, generating a switch-to-focus mode command; calling the remote controller mode switching port to send the switch-to-focus mode command to the remote controller, such that the remote controller enters into a focus mode, and displaying a focus frame on a screen display interface of the smart TV, such that the remote controller controls the focus frame to move.

In another embodiment of the method of the present disclosure, after the control information sent by the remote controller of the smart TV is parsed to be the exit information for exiting the browser, the method further includes:
generating inquiry information for inquiring whether to exit the air mouse mode, and displaying on a smart TV screen;
receiving and parsing feedback information sent by the remote controller of the smart TV;
when the received feedback information is exit confirmation, generating the switch-to-focus mode command; and
when the received feedback information is exit rejection, generating no switch-to-focus mode command, and returning to the previous display interface.

In another embodiment of the method of the present disclosure, when the remote controller enters into the air mouse mode, parsing the control information sent by the remote controller of the smart TV includes:
parsing the control information to obtain mouse movement and operation information; and
executing movement operation to the mouse cursor displayed on the browser interface according to the mouse movement and operation information.

In another embodiment of the method of the present disclosure, when the remote controller enters into the focus mode, parsing the control information sent by the remote controller of the smart TV includes:
parsing the control information to obtain focus direction information; and
executing movement operation to the focus frame on the display interface of the smart TV according to the focus direction information.

In another embodiment of the method of the present disclosure, the way of displaying the inquiry information on the smart TV screen is a dialog box.

A browser-based device for indicating mode switch, characterized by including:
a first parsing module configured to receive and parse control information sent by a remote controller of the smart TV;
a switch-to-air mouse mode command generation module configured to generate a switch-to-air mouse mode command when the control information is request information for entering the browser;
a switch-to-focus mode command generation module configured to generate a switch-to-focus mode command when the control information is exit information for exiting the browser;
a calling module configured to call a remote controller mode switching port;
a sending module configured to send the switch-to-air mouse mode command to the remote controller via the remote controller mode switching port such that the remote controller enters into an air mouse mode; or
send the switch-to-focus mode command to the remote controller via the remote controller mode switching port such that the remote controller enters into a focus mode; and
a display module configured to display a mouse cursor on a browser interface such that the remote controller controls the mouse cursor to move, when the sending module sends the switch-to-air mouse mode command; or
display a focus frame on a screen display interface of the smart TV such that the remote controller controls the focus frame to move, when the sending module sends the switch-to-focus mode command.

In another embodiment of the device of the present disclosure, further including:
an inquiry information generation module configured to generate inquiry information for inquiring whether to exit the air mouse mode and send the inquiry information to the display module to realize displaying on a smart TV screen, when the control information is parsed to be the exit information for exiting the browser; and
a second parsing module configured to receive and parse feedback information sent by the remote controller of the smart TV, trigger the switch-to-focus mode command generation module to generate the switch-to-focus mode command when the received feedback information is exit confirmation, and not trigger the switch-to-focus mode command generation module when the received feedback information is exit rejection, and return to the previous display interface.

In another embodiment of the device of the present disclosure, further including a third parsing module, the third parsing module includes:
an operation parsing module configured to parse the control information to obtain mouse movement and operation information when the remote controller enters into the air mouse module; and
an operation control module configured to execute movement operation to the mouse cursor displayed on the browser interface according to the mouse movement and operation information.

In another embodiment of the device of the present disclosure, further including a fourth parsing module, the focus module includes:
a focus parsing module configured to parse the control signal to obtain focus direction information when the remote controller enters into the focus mode; and
a focus control module configured to execute movement operation to the focus frame on the display interface of the smart TV according to the focus direction information.

A non-transitory computer-readable recording medium having computer programs stored thereon that, when executed by one or more processors of a smart TV, cause the smart TV to perform:
receiving and parsing control information sent by a remote controller of the smart TV;
when the control information is request information for entering the browser, generating a switch-to-air mouse mode command; calling a remote controller mode switching port to send the switch-to-air mouse mode command to the remote controller, such that the remote controller enters into an air mouse mode, and displaying a mouse cursor on a browser interface, such that the remote controller controls the mouse cursor to move;
when the control information is exit information for exiting the browser, generating a switch-to-focus mode command; calling the remote controller mode switching port to send the switch-to-focus mode command to the remote controller, such that the remote controller enters into a focus mode, and displaying a focus frame on a screen display interface of the smart TV, such that the remote controller controls the focus frame to move.

There is further provided a smart TV based on a browser, characterized by including:
a memory having instructions stored thereon;
a processor configured to execute the instructions to perform operations, comprising:
receiving and parse control information sent by a remote controller of the smart TV;
generating a switch-to-air mouse mode command when the control information is request information for entering the browser;
generating a switch-to-focus mode command when the control information is exit information for exiting the browser;
calling a remote controller mode switching port;
sending the switch-to-air mouse mode command to the remote controller via the remote controller mode switching port such that the remote controller enters into an air mouse mode; or
sending the switch-to-focus mode command to the remote controller via the remote controller mode switching port such that the remote controller enters into a focus mode; and
displaying a mouse cursor on a browser interface such that the remote controller controls the mouse cursor to move, when the switch-to-air mouse mode command is sent; or
displaying a focus frame on a screen display interface of the smart TV such that the remote controller controls the focus frame to move, when the switch-to-focus mode command is sent.

An embodiment of the present disclosure discloses browser-based method for indicating mode switch. The method is applied to a smart TV and includes: receiving and parsing control information sent by a remote controller of the smart TV; when the control information is request information for entering the browser, generating a switch-to-air mouse mode command; calling a remote controller mode switching port to send the switch-to-air mouse mode command to the remote controller, such that the remote controller enters into an air mouse mode, and displaying a mouse cursor on a browser interface, such that the remote controller controls the mouse cursor to move; when the control information is exit information for exiting the browser, generating a switch-to-focus mode command; calling the remote controller mode switching port to send the switch-to-focus mode command to the remote controller, such that the remote controller enters into a focus mode, and displaying a focus frame on a screen display interface of the smart TV, such that the remote controller controls the focus frame to move. By using the method, an air mouse mode is started when the smart TV enters into the browser, the mouse cursor is controlled to move on the browser page through the air mouse mode of the remote controller, and the user can browse a web flexibly; and when the smart TV exits a browser interface, a focus mode is started, and focus control over a screen display interface of the smart TV is achieved through the remote controller. The indication mode switching method and device are suitable for the operation habit of the user to a common TV program, and user experience is improved.

### BRIEF DESCRIPTION OF THE DRAWINGS

In order to illustrate technical solutions in the present disclosure more clearly, hereinafter, the Figures which need to be used in describing the embodiments hereinbelow are introduced briefly. Obviously, the Figures described hereinbelow are only some embodiments of the present disclosure, a skilled person in the art may obtain other Figures according to these Figures below without creativity.

FIG. 1 is a flow diagram of browser-based method for indicating mode switch according to a specific embodiment of the present disclosure.

FIG. 2 is a flow diagram of browser-based method for indicating mode switch according to another specific embodiment of the present disclosure.

FIG. 3 is a flow diagram of browser-based method for indicating mode switch according to another specific embodiment of the present disclosure.

FIG. 4 is a flow diagram of browser-based method for indicating mode switch according to another specific embodiment of the present disclosure.

FIG. 5 is a flow diagram of browser-based method for indicating mode switch according to another specific embodiment of the present disclosure.

FIG. 6 is a structural schematic diagram of the browser-based device for indicating mode switch according to a specific embodiment of the present disclosure.

FIG. 7 is a structural schematic diagram of browser-based device for indicating mode switch according to another specific embodiment of the present disclosure.

FIG. 8 is a structural schematic diagram of browser-based device for indicating mode switch according to another specific embodiment of the present disclosure.

FIG. 9 is a structural schematic diagram of browser-based device for indicating mode switch according to another specific embodiment of the present disclosure.

FIG. 10 is a schematic diagram of an application scenario system of browser-based method for indicating mode switch according to the present disclosure.

FIG. 11 is a flow diagram of an application scenario of browser-based method for indicating mode switch according to the present disclosure.

FIG. 12 is a schematic diagram of a TV program interface of the application scenario of browser-based method for indicating mode switch according to the present disclosure.

FIG. 13 is a dialog box schematic diagram of the application scenario of browser-based method for indicating mode switch according to the present disclosure.

FIG. 14 is a schematic diagram of a browser interface of the application scenario of browser-based method for indicating mode switch according to the present disclosure.

FIG. 15 is a flow diagram of another application scenario of browser-based method for indicating mode switch according to the present disclosure.

FIG. 16 is a schematic diagram of a browser interface of another application scenario of browser-based method for indicating mode switch according to the present disclosure.

FIG. 17 is a bubble schematic diagram of an application scenario of browser-based method for indicating mode switch according to the present disclosure.

FIG. 18 is a schematic diagram of a TV program interface of another application scenario of browser-based method for indicating mode switch according to the present disclosure.

### DESCRIPTION OF THE EMBODIMENTS

In order to make one of the objective, technical solution and advantages of the embodiment of the present disclosure more clear, hereinafter, the technical solution in the embodiment of the present disclosure is illustrated clearly and completely with the accompanying drawings in the embodiment of the present disclosure. Based on the embodiment of the present disclosure, a skilled person in the art may obtain all the other embodiments without creativity, which are all in the scope of the present disclosure.

When a user browses the web in a browser of a smart TV, the web is generally controlled and operated using a remote controller. The remote controller controls the smart TV in the following two operating modes: a focus mode and an air mouse mode. In the focus mode, the user presses a button each time to move a focus frame on each icon or link of a browser interface. The air mouse mode is an operating mode for displaying on a smart TV screen in a mouse cursor form. The user clicks a direction button each time to accordingly move web content on the TV screen a certain distance in the direction.

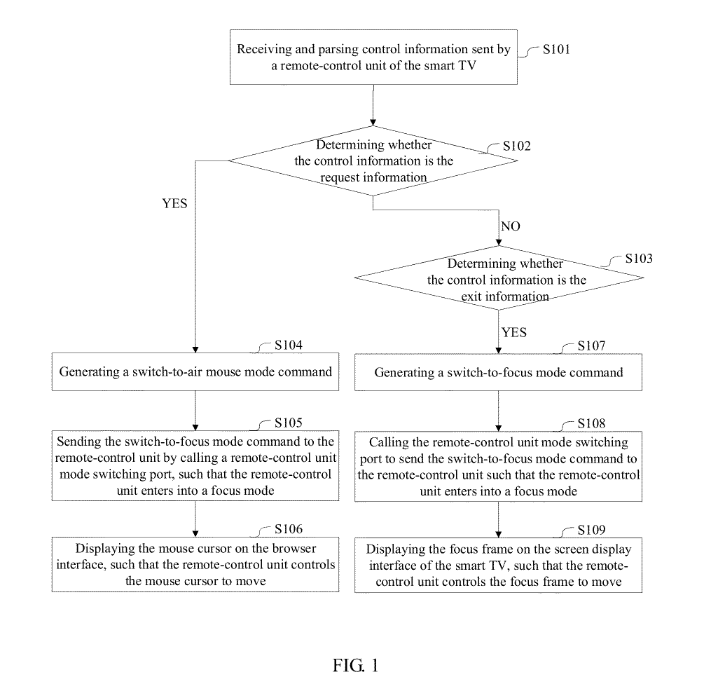

As shown in FIG. 1, a specific embodiment of the present disclosure provides a flow diagram of an indication mode switching method based on a browser, including:
Step S101: receiving and parsing control information sent by a remote controller of the smart TV.

In an operating process of the browser of the smart TV by the user, corresponding control information is generated through the control action over the remote controller and sent to the smart TV; and the control action includes controlling the focus frame or mouse cursor to move, entering into or exiting the browser, etc.

In the specific implementation, when the remote controller is a push-button remote controller, the control action is to push the UDLR (Up, Down, Left, Right) buttons; and when the remote controller is a touch control remote controller, the control action is UDLR sliding movement on a touch panel of the remote controller.

The control information is parsed to obtain the content of the control information. The control information includes: movement information for controlling the focus frame or mouse cursor to move, request information for entering the browser or exit information for exiting the browser.

Step S102: determining whether the control information is the request information; and if so, skipping to step S104; otherwise, executing step S103.

Step S103: determining whether the control information is the exit information; and if so, skipping to step S107.

In the specific implementation, the control information can be switching information generated by pressing a preset switching button on the remote controller by the user, and also can be determination information generated by pressing a YES button when the user selects a link or button set in the smart TV interface through the remote controller. Parsing the control information includes parsing the content contained in the received control information. The content contained in the control information is associated with the smart TV. The parsing needs to be in combination with the content of the current interface of the smart TV. For example, when the control information is switching information generated by pressing the preset switching button on the remote controller by the user, the current interface of the smart TV needs to be combined. When the interface is the browser, the control information is parsed to switch to exit the browser interface, i.e., exiting the browser, thereby obtaining the exit information. When the interface is the TV program interface, the control information is parsed to switch to enter into the browser interface, i.e., entering into the browser, thereby obtaining the request information.

Step S104: generating a switch-to-air mouse mode command.

When the control information obtained by parsing is the request information for entering into the browser, to guarantee that the user can browse the web flexibly in the browser interface, the remote controller of the smart TV should enter into the air mouse mode, thereby generating a switch-to-air mouse mode command.

Step S105: sending the switch-to-air mouse mode command to the remote controller by calling a remote controller mode switching port, such that the remote controller enters into an air mouse mode;

A remote controller mode switching port is specially disposed in the smart TV, through which port the remote controller mode switching command is sent to the remote controller.

In the specific implementation, the smart TV can transmit the remote controller mode switching command to the remote controller through Bluetooth.

When the operating mode of the remote controller for controlling the smart TV needs to be the air mouse mode, the remote control mode switching port is called to send the switch-to-air mouse mode command to the remote controller. When the remote controller receives the switch-to-air mouse mode command, the operating mode is switched to the air mouse mode, and at this point the remote controller can be used as an air mouse.

Step S106: displaying the mouse cursor on the browser interface, such that the remote controller controls the mouse cursor to move.

When the user requests to enter into the browser, the display content of the smart TV is switched to the browser interface in which the remote controller uses the air mouse mode. In order to assisting the operation of the air mouse mode, the mouse cursor is displayed in the browser interface, such that the remote controller in the air mouse mode controls the mouse cursor to move in the browser interface, so as to realize that the operation of the user for browsing the web on the smart TV is similar to that of a computer and is suitable for the operation habit of the user for browsing the web, and user experience is improved.

Step S107: generating a switch-to-focus mode command.

When the control information is the exit information for exiting the browser, it is known that the control action is for exiting the browser. After exiting the browser, the smart TV enters into the TV program interface whose setting is similar to that of a common TV. The user has adapted to the operation to the TV program in the focus mode, and the focus control is performed to the screen display interface of the smart TV through the remote controller, which is suitable for the operation habit of the user to the common TV program and improves the user experience.

In order to guarantee the user can watch the TV program in the TV program interface according to the operation habit, the remote controller of the smart TV needs to enter into the focus mode, generating the switch-to-focus mode command.

Step S108: sending the switch-to-focus mode command to the remote controller by calling a remote controller mode switching port, such that the remote controller enters into a focus mode.

When the operating mode of the remote controller for controlling the smart TV needs to be the focus mode, the remote control mode switching port is called to send the switch-to-focus mode command to the remote controller. When the remote controller receives the switch-to-focus mode command, the operating mode is switched to the focus mode, and at this point, the remote controller controls the focus frame to move on the TV program interface of the smart TV by the UDLR buttons or by touch-controlling the interface to slide.

In the actual implementation, the air mouse switching manner built in the remote controller may not be disabled to guarantee that the user can autonomously select to fast switch to the air mouse mode.

Step S109: displaying the focus frame on the screen display interface of the smart TV, such that the remote controller controls the focus frame to move.

When the user requests to exit the browser, the display content of the smart TV is switched to the TV program interface in which the remote controller uses the focus mode. In order to assisting the operation of the focus mode, the focus frame is displayed in the browser interface, such that the remote controller in the focus mode controls the focus frame to move in the TV program interface, so as to realize that the selection operation when the user watches a TV program on the smart TV is similar to the operation of a common TV and is suitable for the operation habit of the user to the common TV program, and user experience is improved.

In an embodiment of the present disclosure, the air mouse mode is a preferential operating mode, i.e., when the air mouse mode is adopted, the corresponding operation of the focus mode is disabled, and when the focus mode is adopted, the operation of the air mouse mode can be retained to guarantee that the user can autonomously select to quick switch to the air mouse mode.

In the embodiment of the present disclosure, determining whether the control information is the request information is first executed, and then determining whether the control information is the exit information is executed, but in the actual implementation, the order may be reversed.

After the operating mode of the remote controller is switched, the control information sent by the remote controller can continue to be received.

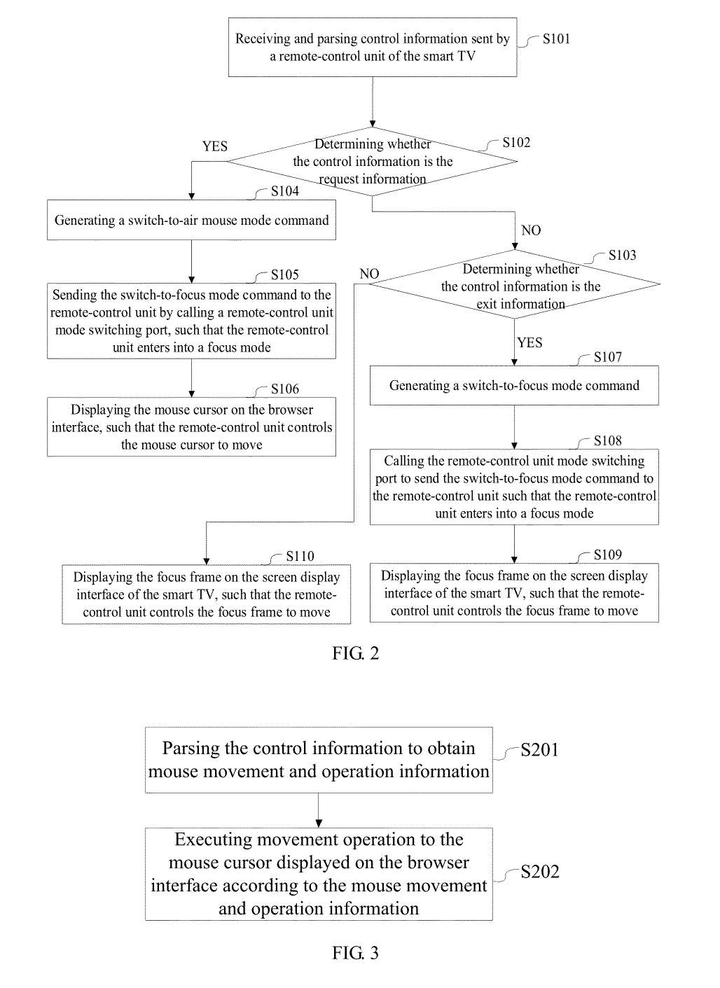

As shown in FIG. 2, another specific embodiment of the present disclosure provides a flow diagram of browser-based method for indicating mode switch, and after step S103, the flow diagram shown in FIG. 1 further includes:

Step S110: when the control information is not the exit information, operating an indication sign in the smart TV interface according to the control information.

The indication sign in the smart TV interface is the mouse cursor when the current operating mode of the remote controller is the air mouse mode, and is the focus frame when the operating mode of the remote controller is the focus mode.

As shown in FIG. 3, when the remote controller is in the air mouse mode, the specific step for parsing the control information includes:

Step S201: parsing the control information to obtain mouse movement and operation information.

When the remote controller is in the air mouse mode, i.e., the remote controller serves as the air mouse, the information sent to the smart TV contains the mouse movement and operation information, and the corresponding focus movement operation is disabled. In the actual implementation, the user switching way can also be disabled to prevent incorrect operation of the user from improperly switching the air mouse mode to the focus mode.

Step S202: executing movement operation to the mouse cursor displayed on the browser interface according to the mouse movement and operation information.

According to the mouse movement and operation information, the mouse cursor displayed in the browser interface can be moved, which is similar to the process of moving the mouse cursor in a computer and thus is not repeated here.

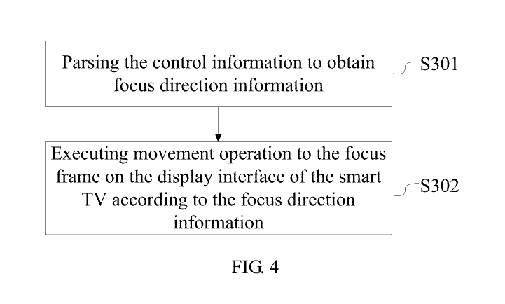

As shown in FIG. 4, when the remote controller is in the focus mode, the specific step for parsing the control information includes:

Step S301: parsing the control information to obtain focus direction information.

When the operating mode of the remote controller is in the focus mode, the control information sent to the smart TV contains direction button information, direction information generated by the swipe gesture of the user on the touch control interface or according to the swipe gesture and the like.

Parsing the control information can obtain focus direction information for controlling the focus movement direction. For example, the down button information sent through the remote controller can obtain the focus direction information “down”, the down swipe gesture of the user on the touch control interface can obtain the focus direction information “down”, or according to the down information generated by the down swipe gesture of the user in the output interface, the focus direction information can be known as “down”. The same focus direction information can be obtained in all manners.

Step S302: executing movement operation to the focus frame on the display interface of the smart TV according to the focus direction information.

According to the focus direction information, the focus frame on the TV program interface of the smart TV can be moved, which is similar to the movement process of the focus frame in the TV and thus is not repeated here.

Steps S101-S110 constitute a process for switching the operating mode of the remote controller, steps S201-S202 constitute a process for controlling the mouse cursor to move in the air mouse mode, and steps S301-S302 constitute a process for controlling the focus frame to move in the focus mode. In another specific embodiment of the present disclosure, the three processes are executed, but not so limited. In the specific implementation, one or two of the processes are executed according to the scenario.

In conclusion, another embodiment of the present disclosure discloses an indication mode switching method based on a browser. The indication mode switching method is applied to a smart TV. With the method, an air mouse mode is started when the smart TV enters into the browser, a mouse cursor is controlled to move on a browser page through the air mouse mode of a remote controller, and a user can browse a web flexibly; and when the smart TV exits a browser interface, a focus mode is started, and focus control over a screen display interface of the smart TV can be achieved through the remote controller. The indication mode switching method is suitable for the operation habit of the user to a common TV program, and user experience is improved.

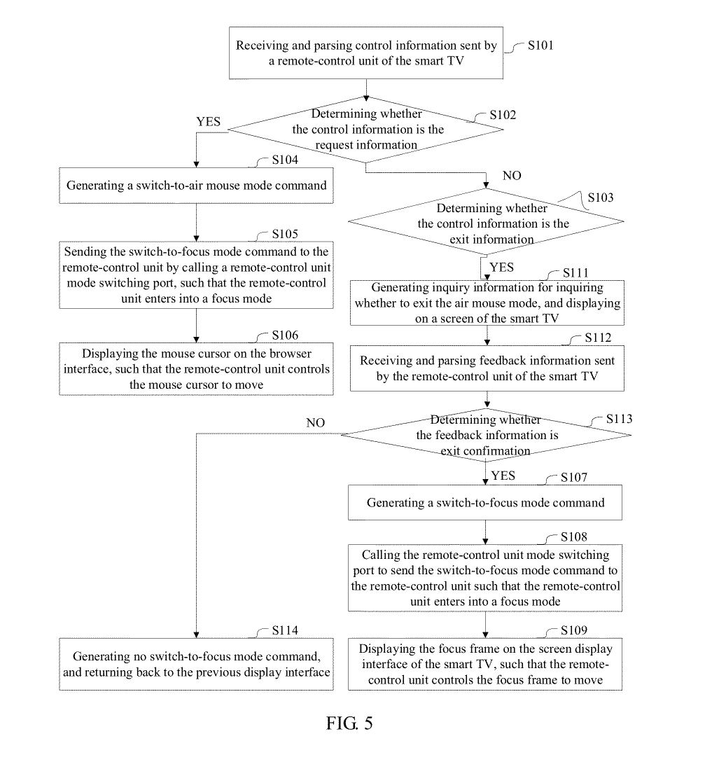

As shown in FIG. 5, another embodiment of the present disclosure provides a flow diagram of browser-based method for indicating mode switch, and between step S103 and step S107, the flow diagram shown in FIG. 1 further includes:

Step S111: generating inquiry information for inquiring whether to exit the air mouse mode, and displaying on a smart TV screen;

When the control information obtained by parsing is the exit information for exiting the browser, the inquiry information for inquiring whether to exit the air mouse mode is generated in order to enable the user to autonomously select the operating mode of the remote controller, and is displayed on the smart TV screen. The operating mode of the remote controller is selected by the user whether to exit the air mouse mode and switch to the focus mode.

In the specific implementation, the manner of displaying the inquiry information on the smart TV screen includes dialog box, bubble, etc.

After seeing the inquiry information displayed on the smart TV screen, the user can use the remote controller to generate feedback information to confirm or reject exiting the air mouse mode according to his/her use habit or usage requirement.

Step S112: receiving and parsing the feedback information sent by the remote controller of the smart TV.

The feedback information sent by the remote controller is received and parsed to determine whether to confirm or rejecting exiting.

Step S113: determining whether the feedback information is the exit confirmation; if so, skipping to step S107; otherwise, executing step S114.

Determining whether the feedback information is exit confirmation; if so, executing step S107 for switching to the focus mode; and if the feedback information is not exit confirmation, i.e., exit rejection, executing step S114.

Step S114: generating no switch-to-focus mode command, and returning back to the previous display interface.

When the feedback information is not exit confirmation, i.e., exit rejection, generating no switch-to-focus mode command, and at this point returning to the previous display interface; and performing the TV program interface in the operating mode of the air mouse mode through the remote controller.

In the specific implementation, when the control information is the request information for entering into the browser, i.e., the smart TV enters into the browser interface, inquiring whether to exit the focus mode can also be executed; when the response of entering confirmation is received, the operating mode of the remote controller is switched to the air mouse mode, and when the response of rejecting switching to the air mouse mode is received, the operating mode of the remote controller is not switched, and the content in the browser web is still operated in the focus mode, and the display of the inquiry information on the smart TV screen is stopped.

In conclusion, another embodiment of the present disclosure discloses an indication mode switching method based on a browser. The user determines whether to switch the operating mode of the remote controller. Depending on the usage requirement of the user, the interactive content of the user in the smart TV operation is increased, and user experience is improved.

The present disclosure further discloses a computer-readable recording medium with a program recorded thereon for executing the above-mentioned method.

The computer-readable recording medium includes any mechanism for storing or transmitting information in a computer-readable form. For example, the machine-readable medium includes Read-Only memory (ROM), Random Access Memory (RAM), disk storage medium, optical storage medium, flash memory, electrically, optically, acoustically or otherwise propagated signal (e.g., carrier, infrared signal, digital signal, etc.) and the like.

Corresponding to the embodiment of browser-based method for indicating mode switch disclosed in the present disclosure, the specification of the present disclosure further discloses an embodiment of an indication mode switching device based on the browser.

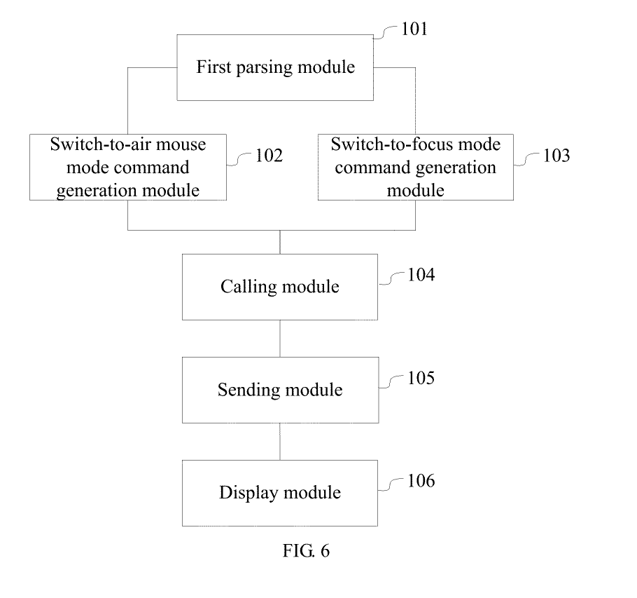

As shown in FIG. 6, the present disclosure discloses a structural schematic diagram of a specific embodiment of browser-based device for indicating mode switch. The device includes: a first paring module 101, a switch-to-air mouse mode command generation module 102, a switch-to-focus mode command generation module 103, a calling module 104, a sending module 105 and a display module 106;

Among the above, the first parsing module 101 is configured to receive and parse control information sent by a remote controller of the smart TV;

In an operating process of the browser of the smart TV by the user, corresponding control information is generated through the control action over the remote controller and sent to the smart TV; and the control action includes: controlling the focus frame or mouse cursor to move, entering into or exiting the browser, etc.

In the specific implementation, when the remote controller is a push-button remote controller, the control action is to push the UDLR (Up, Down, Left, Right) buttons; and when the remote controller is a touch control remote controller, the control action is UDLR sliding movement on a touch panel of the remote controller.

The first parsing module 101 parses the control information to obtain the content of the control information. The control information includes movement information for controlling the focus frame or mouse cursor to move, request information for entering the browser or exit information for exiting the browser.

When the control information obtained by parsing of the first parsing module 101 is the request information for requesting entering into the browser, the switch-to-air mouse mode command generation module 102 is triggered; and when the control information obtained by parsing is the exit information for exiting the browser, the switch-to-focus mode command generation module 103 is triggered.

In the specific implementation, the control information can be switching information generated by pressing a preset switching button on the remote controller by the user, and also can be determination information generated by pressing a YES button when the user selects a link or button set in the smart TV interface through the remote controller. Parsing the control information by the first parsing module 101 includes parsing the content contained in the received control information. The content contained in the control information is associated with the smart TV. While parsing, the first parsing module 101 needs to be in combination with the content of the current interface of the smart TV. For example, when the control information is switching information generated by pressing the preset switching button on the remote controller by the user, the current interface of the smart TV needs to be combined. When the interface is the browser, the control information is parsed by the first parsing module 101 to switch to exit the browser interface, i.e., exiting the browser, thereby obtaining the exit information. When the interface is the TV program interface, the control information is parsed by the first parsing module 101 to switch to enter into the browser interface, i.e., entering into the browser, thereby obtaining the request information.

The switch-to-air mouse mode command generation module 102 is configured to generate a switch-to-air mouse mode command when the control information is request information for entering the browser;

When the control information obtained by parsing is the request information for entering into the browser, to guarantee that the user can browse the web flexibly in the browser interface, the remote controller of the smart TV should enter into the air mouse mode, and a switch-to-air mouse mode command is generated by the switch-to-air mouse mode command generation module 102.

A remote controller mode switching port is specially disposed in the smart TV, through which port the remote controller mode switching command is sent to the remote controller.

In the specific implementation, the smart TV can transmit the remote controller mode switching command to the remote controller through Bluetooth.

When the operating mode of the remote controller for controlling the smart TV needs to be the air mouse mode, the remote control mode switching port is called by the calling module 104, and the switch-to-air mouse mode command is sent to the remote controller by the sending module 105 through the port. When the remote controller receives the switch-to-air mouse mode command, the operating mode is switched to the air mouse mode, and at this point, the remote controller can be used as an air mouse.

When the user requests to enter into the browser, the display content of the smart TV is switched to the browser interface by the display module 106 in which the remote controller uses the air mouse mode. In order to assisting the operation of the air mouse mode, the mouse cursor is displayed in the browser interface, such that the remote controller in the air mouse mode controls the mouse cursor to move in the browser interface, so as to realize that the operation of the user for browsing the web on the smart TV is similar to that in a computer and is suitable for the operation habit of the user for browsing the web, and user experience is improved.

In the specific implementation, in order to simplify the structure of the device, the switch-to-air mouse mode command generation module 102 and the switch-to-focus mode command generation module 103 can be simplified as a switching command generation module. When the mode is switched to the air mouse module, the switch-to-air mouse mode command is generated by the switching command generation module; and when the mode is switched to the focus mode, the switch-to-focus mode command is generated by the switching command generation module.

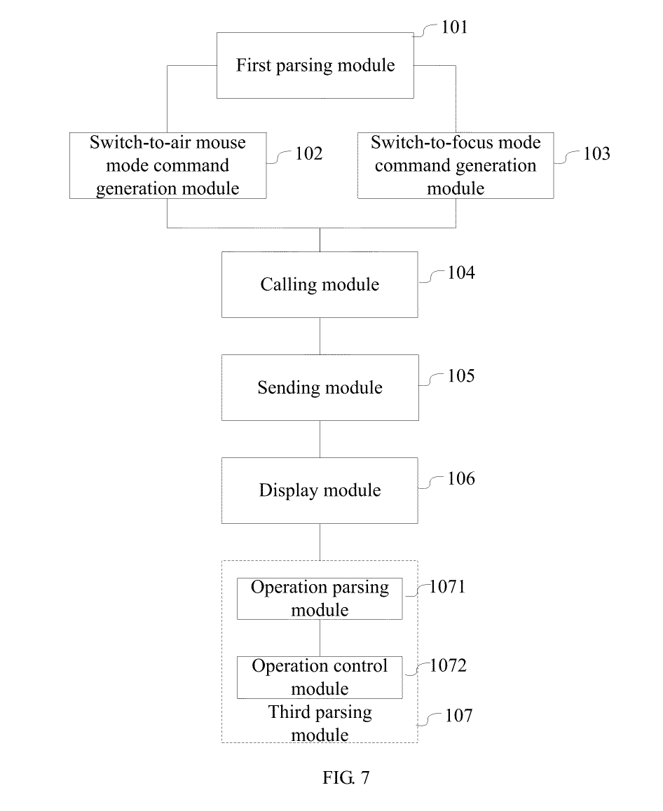

After the remote controller enters into the air mouse mode, the control information sent by the remote controller can continue to be received. Like the structural schematic diagram shown in FIG. 7, the device of the structural schematic diagram shown in FIG. 6 further includes a third parsing module 107. The third parsing module 107 includes an operation parsing module 1071 and an operation control module 1072.

Among the above, the operation parsing module 1071 is configured to parse the control information to obtain mouse movement and operation information when the remote controller enters into the air mouse module;

When the remote controller is in the air mouse mode, the information sent to the smart TV contains the mouse movement and operation information, and the corresponding focus movement operation is disabled. In the actual implementation, the user switching way can also be disabled to prevent incorrect operation of the user from improperly switching the air mouse mode to the focus mode.

Therefore, the operation parsing module 1071 parses the received control information to obtain mouse movement and operation information.

The operation control module 1072 is configured to execute movement operation to the mouse cursor displayed on the browser interface according to the mouse movement and operation information.

According to the mouse movement and operation information, the operation control module 1072 can move the mouse cursor displayed in the browser interface through the display module 106, which is similar to the process of moving the mouse cursor in the computer and thus is not repeated here.

The switch-to-focus mode command generation module 103 is configured to generate a switch-to-focus mode command when the control information is exit information for exiting the browser;

When the control information is the exit information for exiting the browser, it is known that the control action is for exiting the browser. After exiting the browser, the smart TV enters into the TV program interface whose setting is similar to that of a common TV. The user has adapted to the operation to the TV program in the focus mode, and the focus control is performed to the screen display interface of the smart TV through the remote controller, which is suitable for the operation habit of the user to the common TV program and improves the user experience.

In order to guarantee that the user can watch a TV program in the TV program interface according to the operation habit, the remote controller of the smart TV needs to enter into the focus mode, and a switch-to-focus mode command is generated by the switch-to-focus mode command generation module 103.

When the operating mode of the remote controller for controlling the smart TV needs to be the focus mode, the remote control mode switching port is called by the calling module 104, and the switch-to-focus mode command is sent to the remote controller through the sending module 105. When the remote controller receives the switch-to-focus mode command, the operating mode is switched to the focus mode, and at this point the remote controller controls the focus frame to move on the TV program interface of the smart TV by the UDLR buttons or by touch-controlling the interface to slide.

When the user requests to exit the browser, the display content of the smart TV is switched to the TV program interface through the display module 106 in which the remote controller uses the focus mode. In order to assisting the operation of the focus mode, the focus frame is displayed in the browser interface, such that the remote controller in the focus mode controls the focus frame to move in the TV program interface, so as to realize that the selection operation when the user watches TV program on the smart TV is similar to the operation of a common TV and is suitable for the operation habit of the user to the common TV program, and user experience is improved.

In an embodiment of the present disclosure, the air mouse mode is a preferential operating mode, i.e., when the air mouse mode is adopted, the corresponding operation of the focus mode is disabled, and when the focus mode is adopted, the operation of the air mouse mode can be retained to guarantee that the user can autonomously select to quick switch to the air mouse mode.

After the remote controller enters into the focus mode, the control information sent by the remote controller can continue to be received. Like the structural schematic diagram shown in FIG. 8, the device of the structural schematic diagram shown in FIG. 6 further includes a fourth parsing module 108. The fourth parsing module 108 includes a focus parsing module 1081 and a focus control module 1082.

Among the above, the focus parsing module 1081 is configured to parse the control signal to obtain focus direction information when the remote controller enters into the focus mode;

When the operating mode of the remote controller is in the focus mode, the control information sent to the smart TV contains direction button information, direction information generated by the swipe gesture of the user on the touch control interface or according to the swipe gesture and the like.

Parsing the control information by the focus parsing module 1081 can obtain focus direction information for controlling the focus movement direction. For example, the down button information sent through the remote controller can obtain the focus direction information “down”, the down swipe gesture of the user on the touch control interface can obtain the focus direction information “down”, or according to the down information generated by the down swipe gesture of the user in the output interface, the focus direction information can be known as “down”. The same focus direction information can be obtained in all manners.

In the actual implementation, the air mouse switching manner built in the remote controller may not be disabled to guarantee that the user can autonomously select to fast switch to the air mouse mode.

The focus control module 1082 is configured to perform movement operation to the focus frame on the display interface of the smart TV according to the focus direction information.

According to the focus direction information, the focus control module 1082 can move the focus frame on the TV program interface of the smart TV, which is similar to the movement process of the focus frame in the TV and thus is not repeated here.

In the specific implementation, in order to simplify the structure of the device, the functions of the first parsing module 101, the third parsing module 107 and the fourth parsing module 108 can be realized by the same component that parses the received control information. When the control information is the request information for entering into the browser, the switch-to-air mouse mode command generation module 102 is triggered, and after entering into the air mouse mode, the control information sent by the remote controller in the air mouse mode is parsed and processed; and when the control information is the exit information for exiting the browser, the switch-to-focus mode command generation module 103 is triggered, and after entering into the focus mode, the control information sent by the remote controller in the focus mode is parsed and processed.

In conclusion, a specific embodiment of the present disclosure discloses an indication mode switching device based on a browser. Browser-based device for indicating mode switch is applied to a smart TV. With the device, an air mouse mode is started when the smart TV enters into the browser, a mouse cursor is controlled to move on a browser page through the air mouse mode of a remote controller, and a user can browse a web flexibly; and when the smart TV exits a browser interface, a focus mode is started, and focus control over a screen display interface of the smart TV can be achieved through the remote controller. The indication mode switching device is suitable for the operation habit of the user to a common TV program, and user experience is improved.

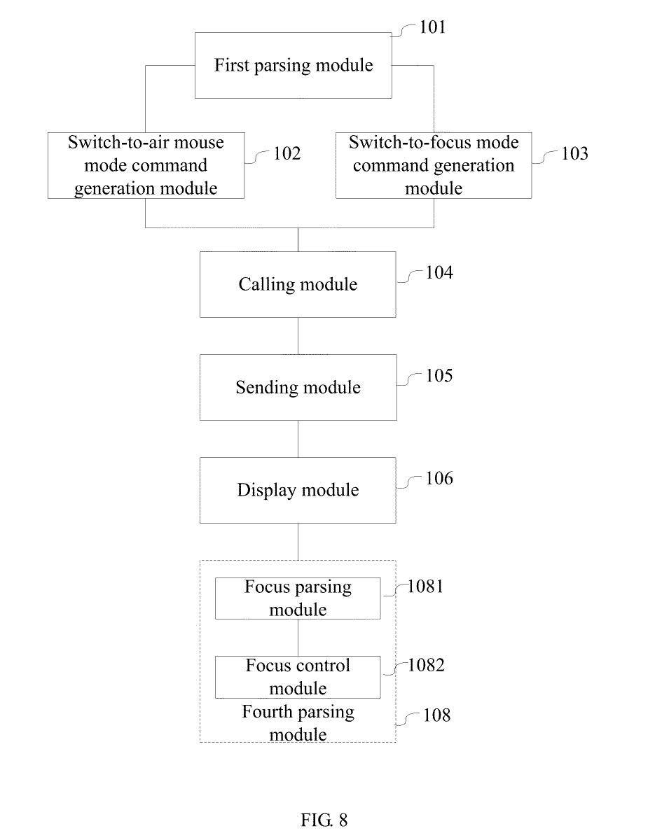

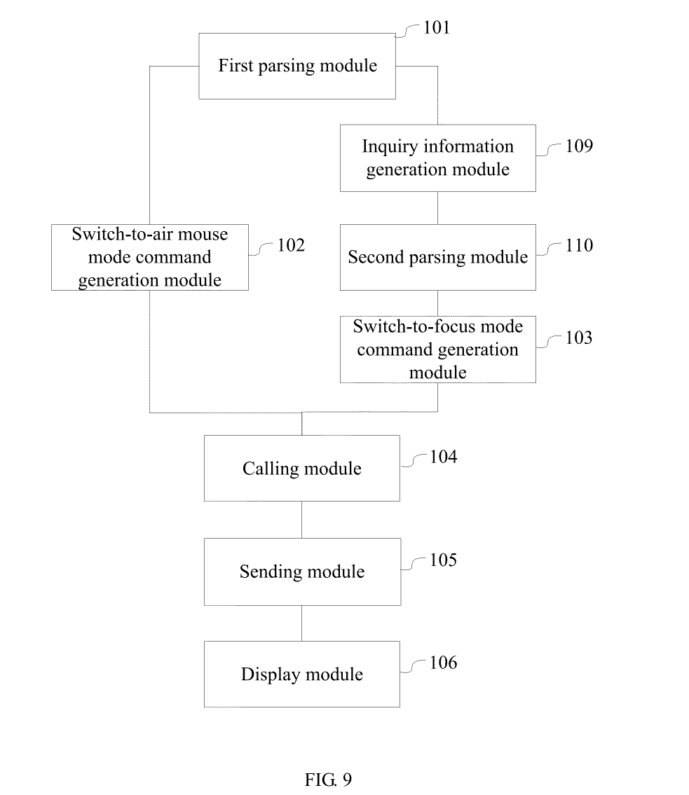

As shown in FIG. 9, another specific embodiment of the present disclosure discloses a structural schematic diagram of browser-based device for indicating mode switch. The structure shown in FIG. 6 further includes: an inquiry information generation module 109 and a second parsing module 110;

Among the above, the inquiry information generation module 109 is configured to generate inquiry information for inquiring whether to exit the air mouse mode and send the inquiry information to the display module 106 to realize displaying on the smart TV screen, when the control information is parsed to be the exit information for exiting the browser;

When the control information obtained by parsing is the exit information for exiting the browser, the inquiry information for inquiring whether to exit the air mouse mode is generated by the inquiry information generation module 109 in order to enable the user to autonomously select the operating mode of the remote controller, and is displayed on the smart TV screen. The operating mode of the remote controller is selected by the user whether to exit the air mouse mode and switch to the focus mode.

In the specific implementation, the manner of displaying the inquiry information on the smart TV screen includes dialog box, bubble, etc.

After seeing the inquiry information displayed on the smart TV screen, the user can use the remote controller to generate feedback information to confirm or reject exiting the air mouse mode according to his/her use habit or usage requirement.

Among the above, the second parsing module 110 is configured to receive and parse feedback information sent by the remote controller of the smart TV, trigger the switch-to-focus mode command generation module 103 to generate the switch-to-focus mode command when the received feedback information is exit confirmation, and not trigger the switch-to-focus mode command generation module 103 when the received feedback information is exit rejection, and return to the previous display interface.

The feedback information sent by the remote controller is received and parsed by the second parsing module 110 to determine whether to confirm or rejecting exiting.

The feedback information is determined whether it is exit confirmation; and if so, the switch-to-focus mode command generation module 103 is triggered to generate the switch-to-focus mode command.

When the feedback information is not exit confirmation, i.e., exit rejection, the switch-to-focus mode command generation module 103 is not triggered, the switch-to-focus mode command is not generated, and at this point back to the previous display interface; and the TV program interface is operated in the operating mode of the air mouse mode through the remote controller.

In the specific implementation, when the control information is the request information for entering into the browser, i.e., the smart TV enters into the browser interface, inquiring whether to switch to the air mouse mode can also be executed; when the response of entering confirmation is received, the operating mode of the remote controller is switched to the air mouse mode, and when the response of rejecting switching to the air mouse mode is received, the operating mode of the remote controller is not switched, and the content in the browser web is still operated in the focus mode, and the display of the inquiry information on the smart TV screen is stopped.

In conclusion, the specific embodiment discloses an indication mode switching device based on a browser. The user determines whether to switch the operating mode of the remote controller. Depending on the usage requirement of the user, the interactive content of the user in the smart TV operation is increased, and user experience is improved.

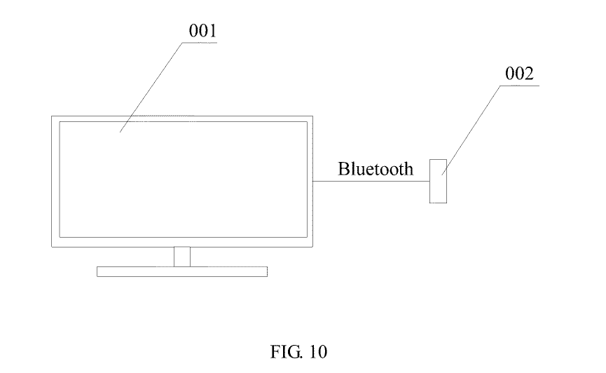

The present disclosure discloses a specific application scenario of the indication model switching method based on the browser. In the schematic diagram of the application scenario system as shown in FIG. 10, the scenario includes a smart TV 001 and a remote controller 002 with command (switch-to-air mouse mode command and switch-to-focus mode command) for switching transmission mode through Bluetooth technology.

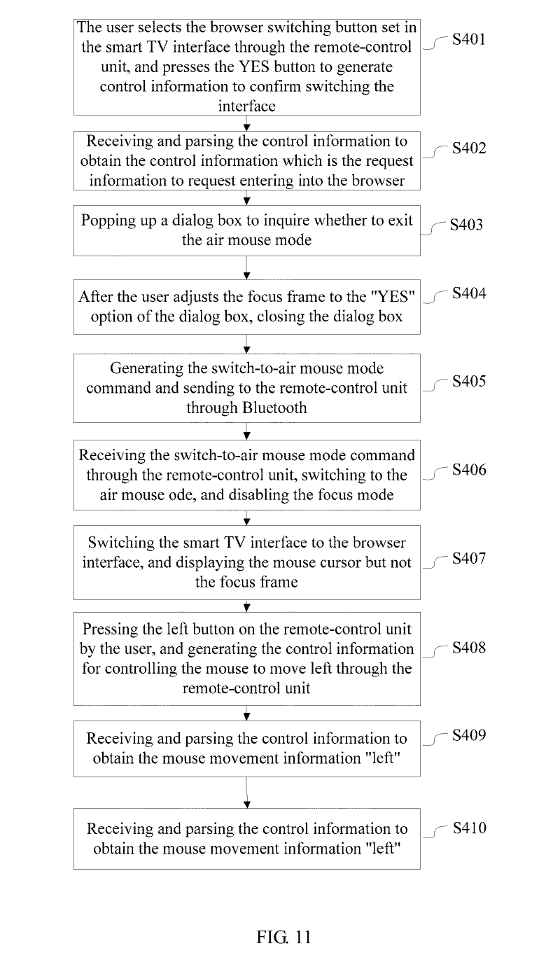

An application scenario includes an indication mode switching process when entering into the browser. The specific process is shown in FIG. 11.

Step S401: the user selecting the browser switching button set in the smart TV interface through the remote controller, and pressing the YES button to generate control information to confirm switching the interface.

The schematic diagram of the current TV interface is shown as the TV program interface 201 in FIG. 12, and the current TV program interface 201 defaults to the focus mode. The interface contains “setting” and “program menu” buttons, as well as a browser switching button 202. The user moves the focus frame to the button 202 and clicks the button to execute the browser switching process.

In this scenario, the buttons in the TV program interface are arranged as shown in FIG. 12, but not limited to such arrangement and display manner, and other manners can also be adopted.

Step S402: receiving and parsing the control information to obtain the control information that is the request information for requesting entering into the browser.

Step S403: popping up a dialog box to inquire whether to exit the air mouse mode.

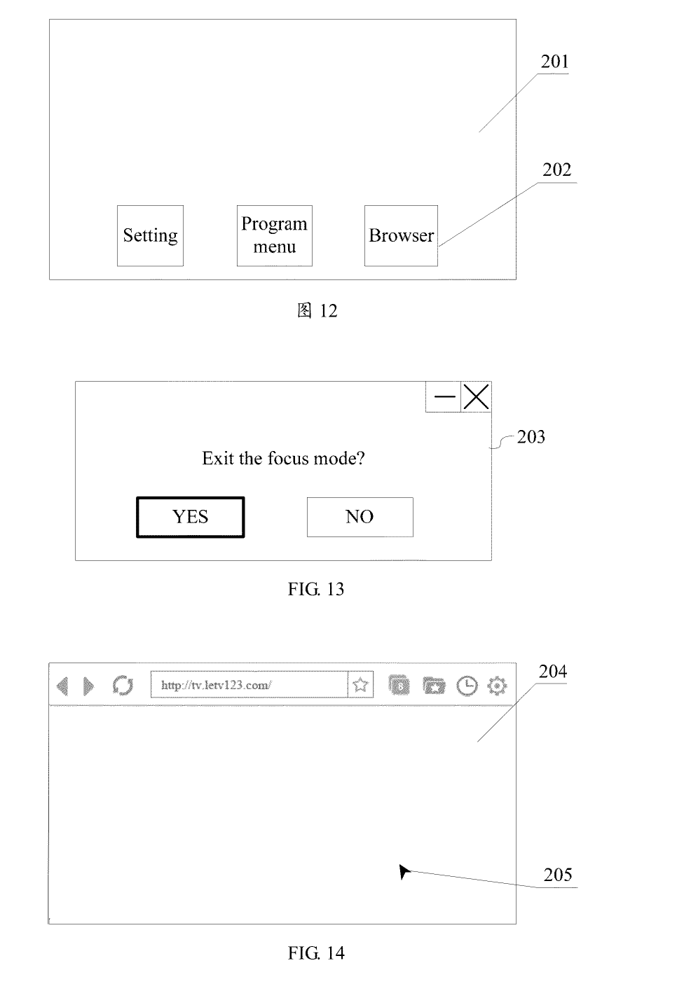

The schematic diagram of the dialog box is shown in FIG. 13. The dialog box 203 shows: “Whether to exit the focus mode?”, and the dialog box contains two options: “YES” and “NO”.

Step S404: after the user adjusts the focus frame to the “YES” option of the dialog box, closing the dialog box.

Step S405: generating the switch-to-air mouse mode command and sending to the remote controller through Bluetooth.

Step S406: receiving the switch-to-air mouse mode command through the remote controller, switching to the air mouse ode, and disabling the focus mode.

Step S407: switching the smart TV interface to the browser interface, and displaying the mouse cursor but not the focus frame.

As shown in FIG. 14, the smart TV interface is switched to the browser interface 204 that contains the mouse cursor 205, and the focus frame is not displayed.

Step S408: pressing the left button on the remote controller by the user, and generating the control information for controlling the mouse to move left through the remote controller.

Step S409: receiving and parsing the control information to obtain the mouse movement information “left”.

Step S410: moving the mouse cursor displayed on the browser interface left according to the mouse movement information “left”.

In this application scenario, steps S401-S407 constitute a process for switching to the air mouse mode, and the subsequent steps S408-S410 constitute a process for controlling movement operation of the mouse cursor in the air mouse mode. In the specific implementation, the two processes are not bound together, i.e., one of them can be executed, i.e., the switching process or the process for controlling the movement operation of the mouse cursor.

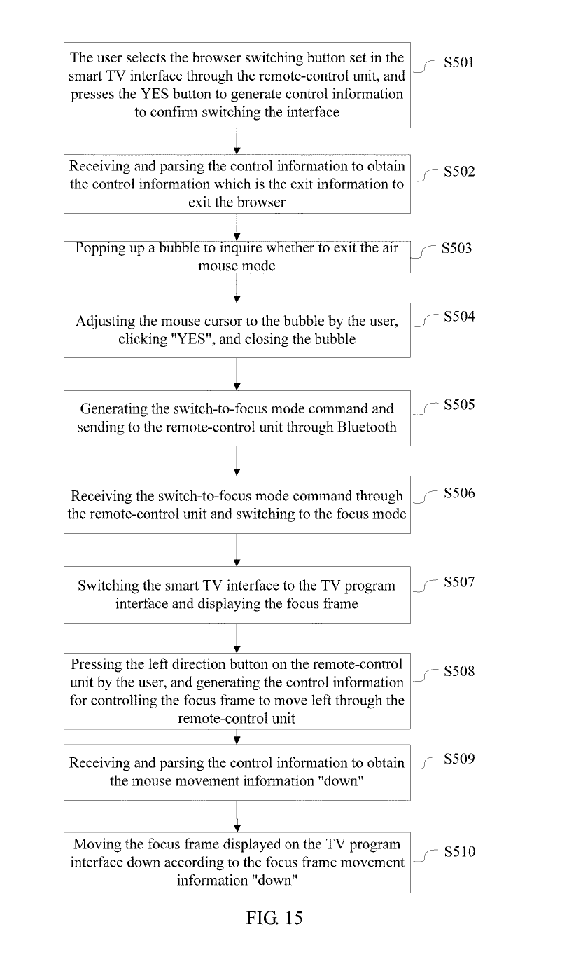

Another application scenario includes an indication mode switching process when exiting the browser. The specific process is shown in FIG. 15.

Step S501: the user selecting the browser switching button set in the smart TV interface through the remote controller, and pressing the YES button to generate control information to confirm switching the interface.

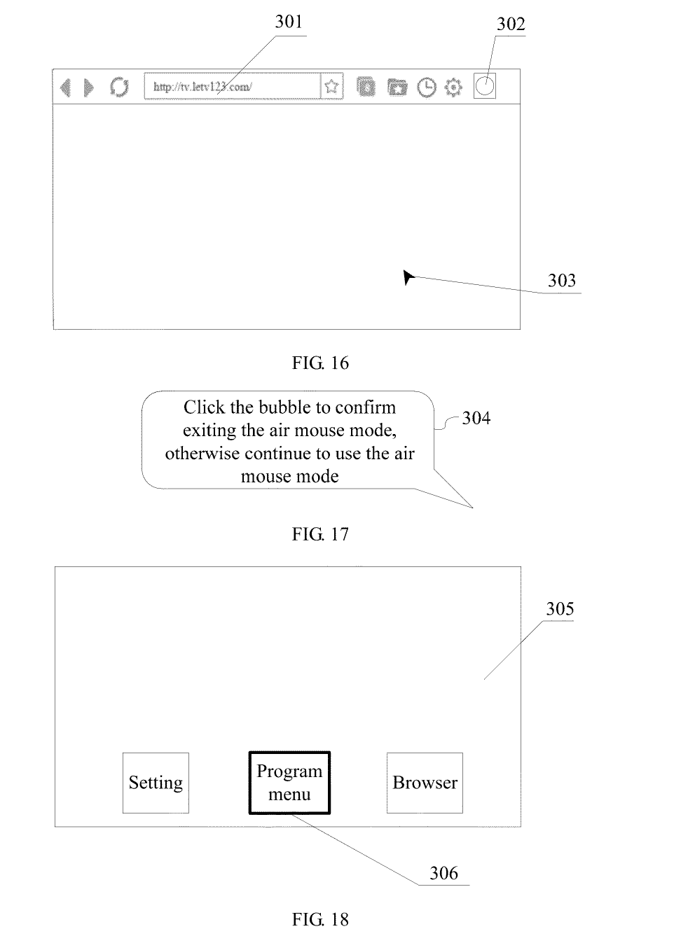

In the schematic diagram of the current TV interface shown in FIG. 16, the current TV interface is the browser interface 301. The current browser interface 301 defaults to the air mouse mode. The interface contains a browser switching button 302. The user moves the focus cursor 303 to the button and clicks the button to execute the TV program interface switching process.

In this scenario, the browser switching button in the browser interface is arranged as shown in FIG. 16, but not limited to such arrangement and display manner, and other manners can also be adopted.

Step S502: receiving and parsing the control information to obtain the control information that is the exit information for exiting the browser.

Step S503: popping up a bubble to inquire whether to exit the air mouse mode.

The bubble is shown as bubble 304 in FIG. 17, which shows: “Click the bubble to confirm exiting the air mouse mode, otherwise continue to use the air mouse mode”.

Step S504: adjusting the mouse cursor to the bubble by the user, clicking “YES”, and closing the bubble.

Step S505: generating the switch-to-focus mode command and sending to the remote controller through Bluetooth.

Step S506: receiving the switch-to-focus mode command through the remote controller and switching to the focus mode.

Step S507: switching the smart TV interface to the TV program interface and displaying the focus frame.

As shown in FIG. 18, the smart TV interface is switched to the TV program interface 305 that contains a focus frame 306.

Step S508: pressing the left direction button on the remote controller by the user, and generating the control information for controlling the focus frame to move left through the remote controller.

Step S509: receiving and parsing the control information to obtain the mouse movement information “left”.

Step S510: moving the focus frame displayed on the TV program interface left according to the focus frame movement information “left”.

In this application scenario, steps S501-S507 constitute a switching process, and the subsequent steps S508-S510 constitute a process for controlling the movement operation of the focus frame in the focus mode. In the specific implementation, the two processes are not bound together, i.e., one of them can be executed, i.e., the switching process or the process for controlling the movement operation of the focus frame.

The above describes in details the indication mode switching method and device according to the present disclosure. In this paper, the specific examples are used to describe the principle and the embodiments of the present disclosure. The description on the embodiments as above is used only to help understanding the methods and its core ideas of the present disclosure; meanwhile, ordinary technical personnel skilled in the art can accord to the idea of the present disclosure to modify the concrete embodiments and the application scope. In summary, the contents in the specification shall not be understood as any limit on the present disclosure.

1. A browser-based method for indicating mode switch, the method being applied to a smart TV, characterized by comprising:
receiving and parsing control information sent by a remote controller of the smart TV;
when the control information is request information for entering the browser, generating a switch-to-air mouse mode command; calling a remote controller mode switching port to send the switch-to-air mouse mode command to the remote controller, such that the remote controller enters into an air mouse mode, and displaying a mouse cursor on a browser interface, such that the remote controller controls the mouse cursor to move;
when the control information is exit information for exiting the browser, generating a switch-to-focus mode command; calling the remote controller mode switching port to send the switch-to-focus mode command to the remote controller, such that the remote controller enters into a focus mode, and displaying a focus frame on a screen display interface of the smart TV, such that the remote controller controls the focus frame to move.

2. The method according to claim 1, characterized in that, after the control information sent by the remote controller of the smart TV is parsed to be the exit information for exiting the browser, the method further comprises:
generating inquiry information for inquiring whether to exit the air mouse mode, and displaying on a smart TV screen;
receiving and parsing feedback information sent by the remote controller of the smart TV;
when the received feedback information is exit confirmation, generating the switch-to-focus mode command; and
when the received feedback information is exit rejection, generating no switch-to-focus mode command, and returning to the previous display interface.

3. The method according to claim 1, characterized in that, when the remote controller enters into the air mouse mode, parsing the control information sent by the remote controller of the smart TV comprises:
parsing the control information to obtain mouse movement and operation information; and
executing movement operation to the mouse cursor displayed on the browser interface according to the mouse movement and operation information.

4. The method according to claim 1, characterized in that, when the remote controller enters into the focus mode, parsing the control information sent by the remote controller of the smart TV comprises:
parsing the control information to obtain focus direction information; and
executing movement operation to the focus frame on the display interface of the smart TV according to the focus direction information.

5. The method according to claim 2, characterized in that, the way of displaying the inquiry information on the smart TV screen is a dialog box.

6. A smart TV, characterized by comprising:
a memory having instructions stored thereon;
a processor configured to execute the instructions to perform operations, comprising:
a first parsing module configured to receive receiving and parse control information sent by a remote controller of the smart TV;
generating a switch-to-air mouse mode command when the control information is request information for entering a browser;
generating a switch-to-focus mode command when the control information is exit information for exiting the browser;
calling a remote controller mode switching port;
sending the switch-to-air mouse mode command to the remote controller via the remote controller mode switching port such that the remote controller enters into an air mouse mode; or
sending the switch-to-focus mode command to the remote controller via the remote controller mode switching port such that the remote controller enters into a focus mode; and
displaying a mouse cursor on a browser interface such that the remote controller controls the mouse cursor to move, when the switch-to-air mouse mode command is sent; or
displaying a focus frame on a screen display interface of the smart TV such that the remote controller controls the focus frame to move, when the switch-to-focus mode command is sent.

7. The smart TV according to claim 6, characterized in that the processor is further configured to perform:
generating inquiry information for inquiring whether to exit the air mouse mode and sending the inquiry information to the display module to realize displaying on a smart TV screen, when the control information is parsed to be the exit information for exiting the browser; and
receiving and parsing feedback information sent by the remote controller of the smart TV, generating the switch-to-focus mode command when the received feedback information is exit confirmation, and returning to the previous display interface when the received feedback information is exit rejection.

8. The smart TV according to claim 6, characterized in that the processor is further configured to perform:
parsing the control information to obtain mouse movement and operation information when the remote controller enters into the air mouse module; and
executing movement operation to the mouse cursor displayed on the browser interface according to the mouse movement and operation information.

9. The smart TV according to claim 6, characterized in that, the processor is further configured to perform:
parsing the control signal to obtain focus direction information when the remote controller enters into the focus mode; and
executing movement operation to the focus frame on the display interface of the smart TV according to the focus direction information.

10. A non-transitory computer-readable recording medium having computer programs stored thereon that, when executed by one or more processors of a smart TV, cause the smart TV to perform:
receiving and parsing control information sent by a remote controller of the smart TV;
when the control information is request information for entering a browser, generating a switch-to-air mouse mode command; calling a remote controller mode switching port to send the switch-to-air mouse mode command to the remote controller, such that the remote controller enters into an air mouse mode, and displaying a mouse cursor on a browser interface, such that the remote controller controls the mouse cursor to move;
when the control information is exit information for exiting the browser, generating a switch-to-focus mode command; calling the remote controller mode switching port to send the switch-to-focus mode command to the remote controller, such that the remote controller enters into a focus mode, and displaying a focus frame on a screen display interface of the smart TV, such that the remote controller controls the focus frame to move.
